(19) United States
(12) Patent Application Publication
(10) Pub. No.: US 2025/0203282 A1
(43) Pub. Date: Jun. 19, 2025

(54) Acoustic Echo Cancellation For Digital Assistants Using Neural Echo Suppression and Multi-Microphone Noise Reduction

(71) Applicant: Google LLC, Mountain View, CA (US)

(72) Inventors: Jens Heitkaemper, Mountain View, CA (US); Arun Narayanan, Milpitas, CA (US); Turaj Zakizadeh Shabestary, San Francisco, CA (US); Sankaran Panchapagesan, Lexington, MA (US); James Walker, Wellesley, MA (US); Bhalchandra Gajare, San Diego, CA (US); Shlomi Itshak Regev, Bromma (SE); Alexander H. Gruenstein, Mountain View, CA (US); Ajay Dudani, Mountain View, CA (US)

(73) Assignee: Google LLC, Mountain View, CA (US)

(21) Appl. No.: 18/954,430

(22) Filed: Nov. 20, 2024

Related U.S. Application Data
(60) Provisional application No. 63/611,721, filed on Dec. 18, 2023.

(51) Int. Cl. H04R 3/02

(52) U.S. Cl. CPC H04R 3/02

(57) ABSTRACT

A method includes receiving a frequency-domain representation of an output audio signal output from a linear acoustic echo canceller (LAEC). The output audio signal includes target speech captured by an audio capture device of a user device and residual echo of reference audio output by an audio output device of the user device. The method also includes receiving a frequency-domain representation of the reference audio and determining, using a neural echo suppressor (NES), based on the frequency-domain representation of the output audio signal and the frequency-domain representation of the reference audio, a time-frequency mask. The method also includes processing, using the time-frequency mask, the frequency-domain representation of the output audio signal to attenuate the residual echo in an enhanced audio signal.

### CROSS-REFERENCE TO RELATED APPLICATIONS

This U. S. Patent Application claims priority under 35 U.S.C. § 119(e) to U.S. Provisional Application 63/611,721, filed on Dec. 18, 2023. The disclosure of this prior application is considered part of the disclosure of this application and is hereby incorporated by reference in its entirety.

### TECHNICAL FIELD

This disclosure relates generally to improving acoustic echo cancellation for digital assistants using neural echo suppression and multi-microphone noise reduction.

### BACKGROUND

Speech-enabled devices are capable of generating synthetic speech and playing back the synthetic speech from an acoustic speaker to one or more users within a speech environment. While the speech-enabled device plays back the synthetic speech, a microphone array of the speech-enabled device may capture an acoustic echo of the synthetic speech while actively capturing target speech spoken by a user directed toward the speech-enabled device. Unfortunately, the acoustic echo originating from playback of the synthetic speech may make it difficult for a speech recognizer to recognize the target speech spoken by the user that occurs during the acoustic echo of the synthetic speech.

### SUMMARY

One aspect of the disclosure provides a computer-implemented method that when executed on data processing hardware causes the data processing hardware to perform operations that include receiving a frequency-domain representation of an output audio signal output from a linear acoustic echo canceller (LAEC). The output audio signal includes target speech captured by an audio capture device of a user device and residual echo of reference audio output by an audio output device of the user device. The operations also include receiving a frequency-domain representation of the reference audio and determining, using a neural echo suppressor (NES), based on the frequency-domain representation of the output audio signal and the frequency-domain representation of the reference audio, a time-frequency mask. The operations also include processing, using the time-frequency mask, the frequency-domain representation of the output audio signal to attenuate the residual echo in an enhanced audio signal.

Implementations of the disclosure may include one or more of the following optional features. In some implementations, the NES includes one or more self-attention layers. The operations further include, for each respective additional audio capture device of a plurality of additional audio capture devices of the user device, receiving a respective frequency-domain representation of a respective output audio signal output from the LAEC for the respective additional audio capture device, and determining, using a cleaner, based on the respective frequency-domain representations of the respective output audio signals, an estimate of the attenuated residual echo. Here, the respective output audio signal includes respective residual echo. In these implementations, determining the estimate of the attenuated residual echo may include correlating a frequency-domain representation of the enhanced audio signal with each of the respective frequency-domain representations of the respective output audio signals. In these implementations, the cleaner may include a plurality of coefficients and the operations may further include training the plurality of coefficients using a minimum mean square error criterion. Optionally, the operations may include training the plurality of coefficients when target speech is not present or prior to detection of a keyword in target speech.

In some examples, the frequency-domain representation of the output audio signal includes a plurality of log-compressed magnitudes for respective ones of a plurality of frequency sub-bands, while the frequency-domain representation of the reference audio includes a plurality of log-compressed magnitudes for respective ones of the plurality of frequency sub-bands.

In some implementations, the operations further include, for each training step of a plurality of training steps: generating target audio training data including sampled speech of interest and a version of an interfering signal; processing, using the LAEC, the target audio training data and the interfering signal to generate predicted enhanced audio data, the LAEC configured to attenuate the interfering signal in the predicted enhanced audio data; processing, using the NES, the predicted enhanced audio data to generate predicted further enhanced audio data, the NES configured to suppress the interfering signal in the predicted further enhanced audio data; and training coefficients of the NES based on a loss term computed based on the predicted further enhanced audio data and the sampled speech of interest. In these implementations, processing, using the LAEC, the target audio training data and the interfering signal to generate the predicted enhanced audio data may optionally include using, for each training step, randomly sampled LAEC parameters. For instance, at least a portion of the randomly sampled LAEC parameters may reduce a performance of the LAEC. These implementations may further include the loss term including at least one of a time-domain scale-invariant signal-to-noise ratio, an automatic speech recognition encoder loss, or a masking loss.

In some examples, the LAEC is configured to perform echo cancellation based on a frequency-domain representation of the target speech and a frequency-domain representation of the reference audio. Here, the LAEC may be configured to perform echo cancellation based on a first set of frequency-domain sub-bands and the NES may be configured to determine the time-frequency mask based on a second set of frequency-domain sub-bands different from the first set of frequency-domain sub-bands.

Another aspect of the present disclosure provides a system that includes data processing hardware and memory hardware storing instructions that when executed on the data processing hardware causes the data processing hardware to perform operations that include receiving a frequency-domain representation of an output audio signal output from a linear acoustic echo canceller (LAEC). The output audio signal includes target speech captured by an audio capture device of a user device and residual echo of reference audio output by an audio output device of the user device. The operations also include receiving a frequency-domain representation of the reference audio and determining, using a neural echo suppressor (NES), based on the frequency-domain representation of the output audio signal and the frequency-domain representation of the reference audio, a time-frequency mask. The operations also include processing, using the time-frequency mask, the frequency-domain representation of the output audio signal to attenuate the residual echo in an enhanced audio signal.

This aspect of the disclosure may include one or more of the following optional features. In some implementations, the NES includes one or more self-attention layers. The operations further include, for each respective additional audio capture device of a plurality of additional audio capture devices of the user device, receiving a respective frequency-domain representation of a respective output audio signal output from the LAEC for the respective additional audio capture device, and determining, using a cleaner, based on the respective frequency-domain representations of the respective output audio signals, an estimate of the attenuated residual echo. Here, the respective output audio signal includes respective residual echo. In these implementations, determining the estimate of the attenuated residual echo may include correlating a frequency-domain representation of the enhanced audio signal with each of the respective frequency-domain representations of the respective output audio signals. In these implementations, the cleaner may include a plurality of coefficients and the operations may further include training the plurality of coefficients using a minimum mean square error criterion. Optionally, the operations may include training the plurality of coefficients when target speech is not present or prior to detection of a keyword in target speech.

In some examples, the frequency-domain representation of the output audio signal includes a plurality of log-compressed magnitudes for respective ones of a plurality of frequency sub-bands, while the frequency-domain representation of the reference audio includes a plurality of log-compressed magnitudes for respective ones of the plurality of frequency sub-bands.

In some implementations, the operations further include, for each training step of a plurality of training steps: generating target audio training data including sampled speech of interest and a version of an interfering signal; processing, using the LAEC, the target audio training data and the interfering signal to generate predicted enhanced audio data, the LAEC configured to attenuate the interfering signal in the predicted enhanced audio data; processing, using the NES, the predicted enhanced audio data to generate predicted further enhanced audio data, the NES configured to suppress the interfering signal in the predicted further enhanced audio data; and training coefficients of the NES based on a loss term computed based on the predicted further enhanced audio data and the sampled speech of interest. In these implementations, processing, using the LAEC, the target audio training data and the interfering signal to generate the predicted enhanced audio data may optionally include using, for each training step, randomly sampled LAEC parameters. For instance, at least a portion of the randomly sampled LAEC parameters may reduce a performance of the LAEC. These implementations may further include the loss term including at least one of a time-domain scale-invariant signal-to-noise ratio, an automatic speech recognition encoder loss, or a masking loss.

In some examples, the LAEC is configured to perform echo cancellation based on a frequency-domain representation of the target speech and a frequency-domain representation of the reference audio. Here, the LAEC may be configured to perform echo cancellation based on a first set of frequency-domain sub-bands and the NES may be configured to determine the time-frequency mask based on a second set of frequency-domain sub-bands different from the first set of frequency-domain sub-bands.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech environment and system using an acoustic echo cancellation (AEC) system.

FIG. 2 is a schematic view of an example AEC system.

FIG. 3 is a flowchart of an example arrangement of operations for a method of reducing residual echo.

FIG. 4 is a schematic view of an example computing device that may be used to implement the systems and methods described herein.

Like reference symbols in the various drawings indicate like elements.

### DETAILED DESCRIPTION

Speech-enabled devices are capable of generating synthetic speech and playing back the synthetic speech from an audio output device (e.g., an acoustic speaker) to one or more users within a speech environment. Here, synthetic speech refers to audio that originates from the speech-enabled device itself or generated by machine processing systems associated with the speech-enabled device rather than a person or other source of audible sound, such as broadcasted audio, external to the speech-enabled device. Generally speaking, the speech-enabled device outputs, or plays back, synthetic speech generated by a text-to-speech (TTS) system. The TTS system converts text to an output audio stream of synthetic speech that conveys the text, where the synthetic speech is modeled to sound like that of an utterance spoken by a human.

Keyword spotting (KS) and automatic speech recognition (ASR) on a speech-enabled device (e.g., a smart speaker, an vehicle infotainment system, a smart phone, etc.) in the presence of echo caused by interfering signals output by the speech-enabled device are challenging tasks despite improvements in acoustic echo cancellation (AEC). An example scenario includes a user using speech to interact with a digital assistant on a speech-enabled device during audio playback. This scenario is all the more challenging when the audio being played back by the speech-enabled device contains synthetic speech because KS and ASR systems are typically optimized for single-talker conditions. Here, while an audio output device (e.g., an acoustic speaker) of the speech-enabled device outputs/plays back synthetic speech, an audio capture device (e.g., a microphone array of one or more microphones) of the speech-enabled device may be simultaneously capturing (i.e., listening to) audio signals within a speech environment. As a result, an acoustic echo of the synthetic speech played back from the audio output device may be captured by the audio capture device and overlap with target speech captured by the audio capture device that is directed toward the digital assistant. Here, an acoustic echo of the synthetic speech includes a modified or delayed version of the played back synthetic speech. Modifications or delay of the synthetic speech may occur due to the played-back synthetic speech acoustically encountering, being modified by, and/or reflecting off of surfaces in the speech environment. Unfortunately, it is difficult for KS or ASR systems to accurately recognize speech spoken by a user while acoustic echo corresponding to played-back synthetic speech is captured simultaneously. That is, the overlapping acoustic echo may compromise the KS or ASR system's ability to accurately recognize a spoken utterance. Without accurate recognition, the speech-enabled device may fail to accurately respond to, or respond at all to, a query or a command from a spoken utterance by the user. Alternatively, the speech-enabled device may want to avoid using its processing resources attempting to interpret audible sound that is actually acoustic echo from the synthetic speech and/or from the surroundings. Here, an AEC system may cancel the acoustic echo by removing at least a portion of the acoustic echo present in the input audio signal. Despite improvements to AEC systems for reducing echo caused by interfering signals, a residual amount of acoustic echo may remain even after an AEC system reduces the acoustic echo. Moreover, despite improvements to KS and ASR systems, KS and ASR systems may struggle in the presence of residual echo to accurately recognize a spoken utterance. Therefore, there is a need for systems and methods for reducing residual echo.

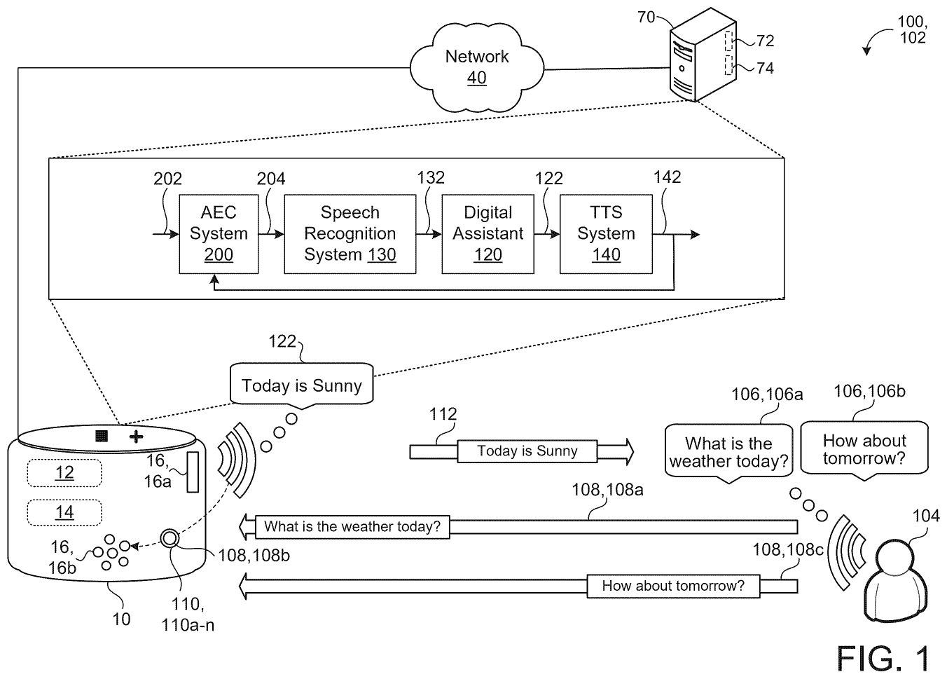

FIG. 1 is a schematic view of an example system 100 and an example speech environment 102 including a user 104 communicating spoken utterances 106, 106a-n to a speech-enabled device 10 (also referred to generally as a user device 10). The user 104 (i.e., speaker of the utterances 106) may speak an utterance 106 as a query or a command to solicit a response from the user device 10. The user device 10 is configured to capture input audio streams 108, 108a-c. Here, an input audio stream 108 is a logical construct that refers to a particular set of associated sounds in the speech environment 102 that occurred during a particular period of time. For example, an input audio stream 108 may represent the user 104 speaking a particular utterance 106 during a particular period of time. The user device 10 captures overlapping input audio streams 108 as a single stream of input audio data 202 that contains an acoustic time-wise sum of the sounds of the overlapping input audio streams 108. The user device 10 may process a particular input audio stream 108 by processing a corresponding portion of input audio data 202 captured by an array of one or more microphones (hereinafter referred to as a ‘microphone array 16b’). However, the values of the corresponding portion of the input audio data 202 will also include contributions from other overlapping input audio streams 108. Here, the user device 10 does not need to specifically know or select what corresponding portion of input audio data 202 to process in order to process a particular input audio stream. Instead, processing a particular input audio stream 108 refers to the processing of input audio data 202 for a particular purpose, or simply the processing of input audio data 202 that includes contributions from the particular input audio stream 108. Similarly, the user device 10 may receive a particular input audio stream 108 by receiving a corresponding portion of input audio data 202 captured by the microphone array 16b. Here, the user device 10 does not need to specifically know or select what corresponding portion of input audio data 202 to receive in order to receive a particular input audio stream 108. Instead, receiving particular input audio data 202 refers to the receiving of input audio data 202 for a particular purpose, or simply the receiving of input audio data 202 that includes contributions from the particular input audio stream 108.

Here, audio sounds may refer to a spoken utterance 106 by the user 104 that functions as an audible query/command directed to the user device 10 or an audible communication captured by the user device 10. Speech-enabled systems 120, 130, and 140 of the user device 10, or associated with the user device 10, may field the query 106 by playing back an audible response to the query 106 as an output audio stream 112, 112a-n, and/or causing the command to be performed. As used herein, an output audio stream 112 is a logical construct that refers to a particular set of associated sounds that are output into the speech environment 102 by the user device 10 during a particular period of time. For example, an output audio stream 112 may represent an audible response to a query 106. Outputting or playing back a particular output audio stream 112 refers to a time-wise addition of audio data representing the particular output audio stream 112 to a buffer of audio data that is being output from an acoustic speaker of the user device 10. Here, the user device 10 may output overlapping, non-overlapping, and partially overlapping output audio streams 112 by generating appropriate alignments of, and time-wise sums of, the audio data corresponding to the output audio streams 112. Input audio streams 108 captured by the user device 10 may also include acoustic echoes 110 captured by the user device 10 as another input audio stream 108b. Here, a particular acoustic echo 110 represents an acoustic echo of a particular output audio stream 112 output, or played back, by the user device 10.

The user device 10 may correspond to any computing device associated with the user 104 and capable of outputting output audio streams and receiving input audio streams. Some examples of user devices 10 include, but are not limited to, mobile devices (e.g., mobile phones, tablets, laptops, etc.), computers, wearable devices (e.g., smart watches, smart goggles, smart glasses, etc.), smart appliances, internet of things (IoT) devices, vehicle infotainment systems, smart speakers, smart assistant devices, etc. The user device 10 includes data processing hardware 12 and memory hardware 14 in communication with the data processing hardware 12 and storing instructions, that when executed by the data processing hardware 12, cause the data processing hardware 12 to perform one or more operations.

The user device 10 includes one or more audio output devices 16, 16a (e.g., one or more acoustic speakers) for communicating or outputting output audio streams 112 representing audio content (e.g., synthetic speech) as one or more output audio streams 112 that encode audio content, and the microphone array 16b for capturing and converting input audio streams 108 within the speech environment 102 into audio data 202 that encodes audio present in the environment 102. While the user device 10 implements an acoustic speaker 16a in the example shown, the user device 10 may implement one or more acoustic speakers 16a either residing on the user device 10, in communication therewith, or a combination where one or more speakers reside on the user device 10 and one or more other speakers that are physically removed from the user device 10 but in communication with the user device 10. Similarly, the user device 10 may implement an array of microphones 16b without departing from the scope of the present disclosure, whereby one or more microphones 16b in the array may not physically reside on the user device 10, but be in communication with interfaces/peripherals of the user device 10. For example, the user device 10 may correspond to a vehicle infotainment system that leverages an array of microphones 16b positioned throughout the vehicle.

In some examples, the user device 10 includes one or more applications (i.e., software applications), where each application may utilize one or more speech processing systems 120, 130, 140 associated with user device 10 to perform various speech processing functions within the application. For instance, the user device 10 may include a digital assistant application 120 configured to converse, through spoken dialog, with the user 104 to assist the user 104 with various tasks. The digital assistant application 120 may be powered by a large language model capable of processing natural language queries 106 to generate responses 122 to the queries. In other examples, the digital assistant application 120 or a media application is configured to playback audible output that includes media content (e.g., music, talk radio, podcast content, television content, movie content, etc.). Here, the digital assistant application 120 may communicate synthetic speech for playback from the acoustic speaker 16a as output audio streams 112 for communicating or conversing with, or assist, the user 104 with the performance of various tasks. For example, the digital assistant application 120 may audibly output synthetic speech that is responsive to queries/commands submitted by the user 104 to the digital assistant application 120. In additional examples, the audible content played back from the acoustic speaker 16a corresponds to notifications/alerts such as, without limitation, a timer ending, an incoming phone call alert, a doorbell chime, an audio message, etc.

The user device 10 may be configured to communicate via a network 40 with a remote computing system 70. The remote computing system 70 may include physical and/or virtual (e.g., cloud based) resources, such as data processing hardware 72 (e.g., remote servers or CPUs) and/or memory hardware 74 (e.g., remote databases or other storage hardware). The user device 10 may utilize the resources 72, 74 to perform various functionalities related to speech processing and/or synthesized playback communication. For instance, the user device 10 may be configured to perform speech recognition using a speech recognition system 130 (e.g., using a speech recognition model) or a KS system (not shown for clarity of illustration). Additionally, the user device 10 may be configured to perform conversion of text to speech using a text-to-speech (TTS) system 140, and acoustic echo cancelation using an acoustic echo cancellation (AEC) system 200. The systems 120, 130, 140, 200 may reside on the user device 10 (referred to as on-device systems) or reside remotely (e.g., reside on the remote computing system 70), but in communication with the user device 10. In some examples, some of the systems 120, 130, 140, 200 reside locally or on-device while others reside remotely. In other words, any of the systems 120, 130, 140, 200 may be local or remote in any combination. For instance, when a system 120, 130, 140, 200 is rather large in size or processing requirements, the system 120, 130, 140, 200 may reside in the remote computing system 70. Yet when the user device 10 may support the size or the processing requirements of one or more systems 120, 130, 140, 200, the one or more systems 120, 130, 140, 200 may reside on the user device 10 using the data processing hardware 12 and/or the memory hardware 14. Optionally, the one or more of the systems 120, 130, 140, 200 may reside on both locally/on-device and remotely. For instance, one or more of the systems 120, 130, 140, 200 may default to execute on the remote computing system 70 when a suitable connection to the network 40 between the user device 10 and remote computing system 70 is available, but when the connection is lost or unsuitable, or the network 40 is unavailable, the systems 120, 130, 140, 200 instead execute locally on the user device 10.

The speech recognition system 130 receives audio data 204 as input and transcribes that audio data 204 into a transcription 132 as output. Generally speaking, by converting the audio data 204 into the transcription 132, the speech recognition system 130 allows the user device 10 to recognize when a spoken utterance 106 from the user 104 corresponds to a query, a command, or some other form of audio communication. The transcription 132 refers to a sequence of text that the user device 10 may then use to generate a response to the query or the command. For instance, if the user 104 asks the user device 10 the query 106a of “what is the weather today,” the user device 10 passes the audio data 204 corresponding to the spoken utterance 106a of “what is the weather today” to the speech recognition system 130. The speech recognition system 130 converts the audio data 204 for the utterance 106a into a transcript 132 that includes the text of “what is the weather today?” The digital assistant 120 may then determine a response to the query 106a using the text or portions of the text. For instance, in order to determine the weather for the current day (i.e., today), the digital assistant 120 passes the text (e.g., “what is the weather today?”) or identifying portions of the text (e.g., “weather” and “today”) to a search engine (not shown for clarify of illustration). The search engine may then return one or more search results that the digital assistant 120 interprets to generate a response for the user 104. Optionally, the digital assistant 120 may leverage the LLM capabilities to perform a task specified by the query 106.

The digital assistant 120 identifies text 122 responsive to a query 106 and the TTS system 140 converts the text 122 into corresponding synthetic speech 142 for the user device 10 to audibly output from the audio output device 16a, user 104. In other words, the TTS system 140 receives, as input, text 132 and converts the text 132 into synthetic speech 142 where the synthetic speech 142 is an output audio signal defining an audible rendition of the text 122. In some examples, the TTS system 140 includes a trained TTS model having a text encoder that encodes the text 122 into an encoded format (e.g., a text embedding) and a decoder that decodes the text embedding into a synthesized speech representation. Here, the synthesized speech representation output by the decoder of the TTS model may be in the frequency-domain (e.g., spectrograms). As such, the TTS system may also include a vocoder (e.g., a neural vocoder) configured to convert the synthesized speech representation in the frequency-domain into time-domain audio characterizing the synthetic speech 142 that audibly conveys the text 122. Once generated, the TTS system 140 communicates the synthetic speech 142 to the user device 10 to allow the user device 10 to output the synthetic speech 142 as an output audio stream 112. For instance, the user device 10 outputs an output audio stream 112a representing “today is sunny” from the speaker 16a of the user device 10. Notably, the TTS system 140 may include the TTS model that converts the text 122

In an example, the speech recognition system 130 receives, via the microphone array 16b, an input audio stream 108a corresponding to a query directed to the digital assistant application 120. The digital assistant 120 then generates an audible response to the query 106a. Here, the speech recognition system 130 may process the input audio stream 108a to generate a transcript 132 of the query and passes the transcript 132 to the digital assistant application 120 so that the digital assistant application 120 can ascertain a text response 122 to the query 106a. Thereafter, the TTS system 140 may convert the text response 122 from the digital assistant application 120 into the synthetic speech 142 for audible output in an output audio stream 112a conveying the response 122 to the query 106a.

With continued reference to FIG. 1, when the user device 10 outputs the synthetic speech 142 (e.g., synthetic speech) in the output audio stream 112a, the synthetic speech 142 may result in an acoustic echo 110 that is captured by the microphone array 16b in another input audio stream 108b. Unfortunately, in addition to the acoustic echo 110, the microphone array 16b may also be simultaneously capturing yet another input audio stream 108c corresponding to another spoken utterance 106b from the user 104 that corresponds to target speech directed toward the user device 10. For example, FIG. 1 depicts that, as the user device 10 outputs the synthetic speech 142 representing “today is sunny” in the output audio stream 112a, the user 104 inquires more about the weather, in another spoken utterance 106b to the user device 10, by asking “how about tomorrow?” Notably, the user 104 speaks the utterance 106b as part of a continued conversation scenario where the user device 10 maintains the microphone array 16b open and the speech recognition system 130 active to permit the user 104 to provide follow-up queries for recognition by the speech recognition system 130 without requiring the user 104 to speak a hotword (e.g., a predetermined word or phrase that when detected triggers the user device 10 to invoke speech recognition). In the example shown, the input audio stream 108c for “how about tomorrow?” temporally overlaps with the output audio stream 112a for “today is sunny.” Thus, microphone array 16b captures both the audio data 202 for the utterance 106b and at least a portion of the acoustic echo 110 corresponding to the synthetic speech 142 played back in the output audio stream 112a. That is, the acoustic echo 110 for the output audio stream 112a and the input audio stream 108c are both captured by the microphone array 16b simultaneously to form the audio data 202.

To resolve this, the user device 10 includes the AEC system 200 for processing the audio data 202 to cancel (i.e., reduce) acoustic echo 110 from output audio data 142 in the audio data 202, and provide the output 204 of the AEC system 200 (possibly including residual echo) to the speech recognition system 130 or a KS system. The AEC system 200 receives input audio data 202 including input audio streams 108b, c captured by the microphone array 16b, the input audio stream 108b including acoustic echo 110 corresponding to a response to a query played back from the acoustic speaker 16a and processes the audio data 202 to generate a respective target audio signal 204 that cancels the acoustic echo 110 of the input audio stream 108.

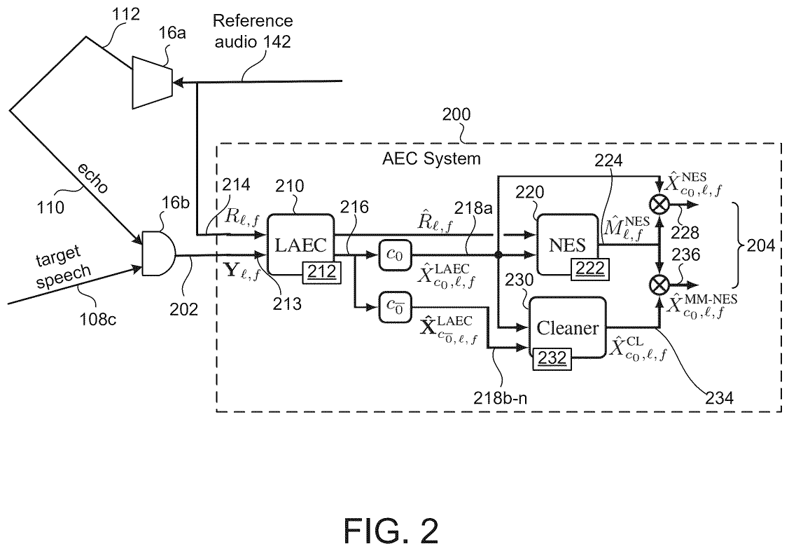

FIG. 2 is a schematic view of an example AEC system 200. In the example of FIG. 2, the AEC system 200 receives a plurality of streams of audio data 202, 202a-n captured by C respective microphones of the microphone array 16b. A vector Y_{l,f} 213 of frequency domain representations of the plurality of streams of audio data 202 at time l and frequency bin f can be expressed as Y_{l,f}=[y_{1,l,f}, . . . y_{c,l,f}]^{T}. The audio data 202 captured by each microphone c can be expressed, using a convolutive transfer function approximation, as

$${Y}_{c , l , f} = {H}_{c , l , f} * {S}_{l , f} + {H}_{c , l , f}^{e} * {R}_{l , f} + {N}_{c , l , f} = {X}_{c , l , f} + {E}_{c , l , f} + {N}_{c , l , f} \qquad EQN ( 1 )$$

where S_{l,f} and R_{l,f} respectively represent the short-time Fourier Transform (STFT) coefficients of a target audio signal 108 and output audio data 142 played back by the speaker 16a. H_{c,l,f} and H_{c,l,f}^{e} are vectors of STFT coefficients of respective relative transfer functions between the user 104 and each of the C microphones, and between the speaker 16b and each of the C microphones 16b. X_{c,l,f} represents multi-microphone STFT coefficients of the target speech 108, E_{c,l,f} represents the echo 110, and N_{c,l,f} represents environmental noise. EQN (1) may alternatively expressed using vector notation as Y_{l,f}=X_{l,f}+E_{l,f}+N_{l,f}. Here, in some implementations, a negligible level of background noise is assumed.

The AEC system 200 includes a linear acoustic echo canceller (LAEC) 210 that receives input audio data 202 encoding one or more overlapping input audio streams 108 and one or more overlapping output audio streams 112. In the example shown in FIG. 1, the input audio data 202 includes both an input audio stream 108c encoding the follow-up utterance 106b (i.e., a target utterance or speech) and an acoustic echo 110 of the audible response 112b. Here, the input audio stream 108c is spoken while the output audio stream 112b (e.g., containing contributions from multiple overlapping output audio streams 112) is being played back. The LAEC 210 processes the output audio data 142 (also referred to herein as reference audio data 142) that is being played back by the acoustic speaker 16a, and the input audio data 202 to generate an estimate of the acoustic echo 110 of the output audio stream 112b present in the input audio data 202.

The LAEC 210 is configured to perform echo cancellation based on a frequency-domain representation 213 of the audio data 202 (which includes target speech 108), and a frequency-domain representation 214 of the reference audio 142. In some implementations, the LAEC 210 implements a frequency-domain sub-band adaptive filter 212 that estimates the echo 110 at a microphone c from the STFT coefficients R_{l,f} 214 of the reference signal 142. Here, filter coefficients \hat{ω}_{c,f}^{LAEC} of the filter 212 may optimized for each sub-band f and the microphone c using a minimum mean-square error (MMSE) criterion, such as

$${\hat{ω}}_{c , f}^{LAEC} = {arg min}_{{ω}_{c , f}} 𝔼 [ {\vert {Y}_{c , l , f} - {ω}_{c , f}^{H} {\tilde{R}}_{l , f} \vert}_{2}^{2} ] \qquad EQN ( 2 )$$

$$where$$

$${\tilde{R}}_{l , f} = {[ {\hat{R}}_{l - {D}_{+ 1 , f}}^{LAEC} , … , {\hat{R}}_{l , f} ]}^{T}$$

is a vector of the STFT coefficients \hat{R} of the reference signal 142 aligned with a temporal context of D^{LAEC} frames, [symbol] is the expectation operator, and |⋅|₂ the L2-norm. Here, \hat{R}_{l,f} is derived from the STFT coefficients R_{l,f} 214 of the reference signal 142 using a cross-correlation based alignment algorithm to correct for shifts between the reference signal 142 and the input audio data 202 due to, for example, inherent device delays during playback and the traversal time between the speaker 16a and the microphone c. The filter 212 estimates the echo 110 for microphone c as Ê_{c,l,f}=(\hat{ω}_{c,f}^{LAEC})^{H}Y_{l,f}, and then subtracts the estimated echo Ê_{c,l,f} from Y_{l,f} 213 to get an initial estimate \hat{X}_{c,l,f}^{LAEC}=Y_{l,f}−Ê_{c,l,f} 216 of the target speech X_{l,f}. Here, the initial estimate \hat{X}_{c,l,f}^{LAEC} 216 of the target speech X_{l,f} may include residual echo that the LAEC 210 was not able to cancel. In some examples, the LAEC 210 operates in a streaming fashion with imperfect information by recursively estimating correlation matrices for computing the filter coefficients \hat{ω}_{c,f}^{LAEC} using an exponential forgetting factor α^{LAEC}.

The AEC system 200 also includes a neural echo suppressor (NES) 220 for reducing residual echo present in the estimate \hat{X}_{c}_{₀}_{,l,f}^{LAEC} 218a of the target speech X_{l,f} for a microphone c₀ of the microphone array 16b output by the LAEC 210. The NES 220 receives the frequency-domain representation \hat{X}_{c}_{₀}_{,l,f}^{LAEC} 218a of an output audio signal output from the LAEC 210, the output audio signal including target speech 108 captured by microphone c₀ and residual echo of reference audio 142 output by the speaker 16a. The NES 220 also receives the frequency-domain representation R_{l,f} 214 of the reference audio 142. The NES 220 determines, based on the frequency-domain representation \hat{X}_{c}_{₀}_{,l,f}^{LAEC} 218a of the output audio signal and the frequency-domain representation R_{l,f} 214 of the reference audio 142, a time-frequency mask \hat{M}_{l,f}^{NES} 224. The NES 220 then processes, using the time-frequency mask \hat{M}_{l,f}^{NES} 224, the frequency-domain representation \hat{X}_{c}_{₀}_{,l,f}^{LAEC} 218a of the output audio signal to attenuate the residual echo in an enhanced audio signal \hat{X}_{c}_{₀}_{,l,f}^{NES} 228.

In particular, the NES 220 includes a neural network based mask estimator 222 that takes, as input, frequency-domain log-compressed magnitudes for an estimate \hat{X}_{c}_{₀}_{,l,f}^{LAEC} 1218a output by the LAEC 210 for microphone c₀ and for the aligned reference signal \hat{R}_{l,f} 214. In some implementations, the mask estimator 222 includes one or more self-attention layers (e.g., four layers, each with 256 units) of a Conformer to combine the information from the estimate \hat{X}_{c}_{₀}_{,l,f}^{LAEC} 216 and \hat{R}_{l,f} 214. In some examples, the mask estimator 222 uses convolutional kernel size of 15, and includes an 8-head masked self-attention block with a left context of 31 frames. Here, the mask estimator 222 estimates, from an output of the Conformer, the time-frequency mask \hat{M}_{l,f}^{NES} 224. The AEC system 220 then multiplies the time-frequency mask \hat{M}_{l,f}^{NES} 224 with the LAEC output \hat{X}_{c}_{₀}_{,l,f}^{LAEC} 218a for microphone c₀ to get a refined estimate \hat{X}_{c}_{₀}_{,l,f}^{NES}=\hat{M}_{l,f}^{NES}*\hat{X}_{c}_{₀}_{,l,f}^{LAEC} 228 of the target speech X_{l,f}. In some examples, the AEC system 200 exponentially scales the time-frequency mask \hat{M}_{l,f}^{NES} 224 by a scaling factor (e.g., 0.5) before multiplying with \hat{X}_{c}_{₀}_{,l,f}^{LAEC} to reduce speech distortion. Notably, the NES 220 operates on frequency-domain features rather than time domain features or log-Mel features, or rather than using a learned separation domain.

In some examples, frequency-domain outputs of the LAEC 210 are used directly as the inputs of the NES 220. Alternatively, frequency-domain outputs of the LAEC 210 are converted back to the time domain, and then re-converted to the frequency-domain for input to the NES 220. Notably, this allows the LAEC 210 and the NES 220 to operate using different frequency-domain resolutions. That is, the LAEC 210 may be configured to perform echo cancellation based on a first set of frequency-domain sub-bands, while the NES 220 is configured to determine the time-frequency mask \hat{M}_{l,f}^{NES} 224 based on a second set of frequency-domain sub-bands different from the first set of frequency-domain sub-bands. Here, generalization performance of the NES 220 may be improved by inputting into the NES 220 a higher frequency-domain resolution (e.g., using a larger window size and shift) representations of the estimates \hat{X}_{c,l,f}^{LAEC} 216 determined by the LAEC 210.

In some implementations, the NES 220 is trained by, for each training step of a plurality of training steps: generating target audio training data 202 including sampled speech of interest 108 and a version of an interfering signal 142; processing, using the LAEC 210, the target audio training data 202 and the interfering signal 142, to generate predicted enhanced audio data 216, the LAEC 210 configured to attenuate the interfering signal 142 in the predicted enhanced audio data 216; processing, using the NES 220, the predicted enhanced audio data 216 to generate predicted further enhanced audio data 228, the NES 220 configured to suppress the interfering signal 142 in the predicted further enhanced audio data 228; and training coefficients of the NES 220 based on a loss term computed based on the predicted further enhanced audio data 228 and the sampled speech of interest 108.

To improve performance of the NES 220 and subsequent speech recognition or keyword spotting, the mask estimator 222 may be trained using one or more weaker LAEC configurations (as compared to the configuration of the LAEC 210 used for inference), so that the mask estimator 222 is exposed to different levels and characteristics of residual echo. The LAEC 210 may be weakened by, for example, adjusting any of the LAEC configuration parameters shown below in Table 1.

TABLE 1
LAEC Configuration Parameters

| Parameter | Distribution |
|---|---|
| D = D^{LAEC} | $Pr ( D = 0 ) = \frac{1}{11}$ and $Pr ( D = 1 ) = \frac{10}{11}$ |
| Frame length L | $Pr ( L = 2048 ) = \frac{1}{4}$ and $Pr ( L = 1024 ) = \frac{3}{4}$ |
| Frame shift O | $Pr ( O = 50 \% ) = \frac{4}{5}$ and $Pr ( L = 25 \% ) = \frac{1}{5}$ |
| Align, error ξ | P(ξ) = [symbol] (−0.01 sec, 0.03 sec) |

In some examples, LAEC configuration parameters are randomly sampled for each training step based on the distributions shown above.

In some implementations, the mask estimator 222 is trained using a combination of one or more losses. Example losses include, but are not limited to, a time-domain scale-invariant signal-to-noise ratio (SNR) loss, an ASR encoder loss of a pre-trained ASR encoder that is kept frozen during training (e.g., an L2-loss between ASR encoder outputs computed from a target waveform and a predicted waveform), and a masking loss that is a combination of L1- and L2-losses between the ideal and predicted STFT masks. In some examples, two or more of these losses are multiplied with an individual fixed weight to approximately equalize their loss value ranges before calculating a weighted sum of the two or more losses. In some examples, a weight for the ASR loss starts off at zero for a first plurality of training steps (e.g., 20,000 steps) and then linearly increases to pre-determined value (e.g., 10,000) over a second plurality of training steps (e.g., 100,000 steps), and then is held fixed.

When multiple microphones 16b are available or used, the AEC system 200 may include a cleaner 230 that, for each particular microphone c, receives a respective frequency-domain representation \hat{X}_{c,l,f}^{LAEC} 218 of a respective output audio signal output from the LAEC 210 for the particular microphone c, the respective output audio signal comprising respective residual echo. The cleaner 230 then determines, based on the respective frequency-domain representations \hat{X}_{c,l,f}^{LAEC} 218 of the respective output audio signals, an estimate of noise (e.g., the attenuated residual echo) in the enhanced audio signal \hat{X}_{c}_{₀}_{,l,f}^{LAEC} 218a for microphone c₀. In some examples, the cleaner 230 determines an estimate of the attenuated residual echo for microphone c₀ by correlating the frequency-domain representation \hat{X}_{c}_{₀}_{,l,f}^{LAEC} 218a of the enhanced audio signal for microphone c₀ with each of the respective frequency-domain representations \hat{X}_{c}_{₀}_{,l,f}^{LAEC} 218b-n of the respective output audio signals for other microphones c_{0̅} of the microphone array 16b.

In some implementations, the cleaner 230 includes a multi-channel linear filter 232 to estimate the attenuated residual echo for microphone c₀. Filter coefficients \hat{ω}_{f}^{CL} of the multi-channel linear filter 232 may be trained using an MMSE criterion, such as:

$${\hat{ω}}_{f}^{CL} = {arg min}_{{ω}_{f}} 𝔼 [ {\vert {Y}_{{c}_{0} , l , f} - {ω}_{f}^{H} {\tilde{Y}}_{{c}_{\overline{0}} , l , f} \vert}_{2}^{2} ] \qquad EQN ( 4 )$$

$$where$$

$${\tilde{Y}}_{{c}_{\overline{0}} , l , f} = {[ {\tilde{Y}}_{{c}_{\overline{0}} , l - {D}^{CL} + 1 , f}^{T} , … , {\tilde{Y}}_{{c}_{\overline{0}} , l , f}^{T} ]}^{T}$$

is a vector of the non-target microphones c_{0̅} with a temporal context D^{CL}, [symbol] is the expectation operator, and |⋅|₂ the L2-norm. The filter 232 estimates the noise (e.g., any further echo) present in the estimate \hat{X}_{c}_{₀}_{,l,f}^{LAEC} 218a of the target speech X_{l,f} for microphone c₀ based on the estimates \hat{X}_{c}_{₀}_{,l,f}^{LAEC} 228b-n of the target speech X_{l,f} for the other microphones c_{0̅} of the microphone array 16b, and then subtracts the estimated noise from the estimate \hat{X}_{c}_{₀}_{,l,f}^{LAEC} 218a to obtain a cleaned signal \hat{X}_{l,f}^{CL} 234. The AEC system 220 may then multiply the time-frequency mask \hat{M}_{l,f}^{NES} 224 with the cleaned output \hat{X}_{c}_{₀}_{,l,f}^{CL} 234 for a target microphone c₀ to get a refined estimate \hat{X}_{c}_{₀}_{,l,f}^{MM-NES}=\hat{M}_{l,f}^{NES}*\hat{X}_{c}_{₀}_{,l,f}^{CL} 236 of the target speech X₁f. The output 204 of the AEC system 200 is selected to be the estimate \hat{X}_{c}_{₀}_{,l,f}^{NES} 228 when only a single microphone 16b is present or used, or selected to be the estimate \hat{X}_{c}_{₀}_{,l,f}^{MM-NES} 236 when multiple microphone 16b are present and used.

In some examples, correlation statistics are estimated recursively using an exponential forgetting factor ac. In some implementations, coefficients \hat{ω}_{f}^{CL} of the multi-channel linear filter 232 are trained on audio data 202 that does not include target speech. While a neural network may be used to identify audio data 202 not including target speech, when a speech-based digital assistant 120 is invoked using a keyword, audio data 202 proceeding a keyword can be assumed to be noise and used for training. Thus, in some examples, coefficients \hat{ω}_{f}^{CL} of the filter 232 are trained using audio data 202 preceding a keyword detector being triggered, and are then held frozen and used to get an estimate of the interfering signal 142, which may then be subtracted from the estimate X_{c}_{₀}_{,l,f}^{LAEC} 218 to obtain the cleaned signal \hat{X}_{l,f}^{CL} 234.

Unlike the LAEC 210, the cleaner 230 relies on spatial information to enhance the signal Y_{l,f} 213. The cleaner 230 estimates noise present in audio data 202 for a target microphone c₀ 16b using information present in audio data 202 for other microphones ca 16b by assuming a spatially stationary interfering source. When the speaker 16a is playing back audio while the audio data 202 is captured, the cleaner 230 may also address residual echo remaining after the LAEC 210 because the interfering source (i.e., the speaker 16a) is a stationary source. When background noise is negligible, the cleaner 230 may be optimized to suppress residual echo. In some implementations, the cleaner 230 is configured using D=3, α^{CL}=0.99, an STFT window size of 128 ms with 50% overlap, and an FFT size of 2048.

While FIG. 2 shows a particular arrangement of the LAEC 210, the NES 220 and the cleaner 230, there are various other possibilities for using the cleaner 230 in the AEC system 200 to make use of multiple microphones c 16b. In the example shown, the LAEC 210 is executed first to perform initial echo cancellation. However, the order of NES 220 and the cleaner 230 may varied to find an optimal combination. When considering various combination strategies, one goal may be to reuse the same NES 220 for both single and multi-microphone residual echo suppression without retraining. Notably, having a single NES 200 simplifies deployment on several user devices 10 without the need for additional tuning or training. The various combinations may be distinguished based on the inputs to NES 220, the inputs to cleaner 230, and the signal to which the estimated mask \hat{M}_{l,f}^{NES} 224 is applied, as shown below in Table 2.

TABLE 2
NES and Cleaner Combinations

| | | Cleaner | Masked |
|---|---|---|---|
| System | NES inputs | input | signal |
| NES | \hat{R}, \hat{X}^{LAEC} | — | \hat{X}^{LAEC} |
| Cleaner → NES | \hat{R}, \hat{X}^{CL} | \hat{X}^{LAEC} | \hat{X}^{CL} |
| NES → Cleaner | \hat{R}, \hat{X}^{LAEC} | \hat{X}^{NES} | \hat{X}^{LAEC} |
| MM-NES | \hat{R}, \hat{X}^{LAEC} | \hat{X}^{LAEC} | \hat{X}^{CL} |

For “NES”—the mask \hat{M}_{l,f}^{NES} 224 is applied to the output \hat{X}_{c}_{₀}_{,l,f}^{LAEC} 218a of the LAEC 210. For “Cleaner->NES”—the output \hat{X}_{c}_{₀}_{,l,f}^{LAEC} 218a of the LAEC 210 is input to the cleaner 230, and the output \hat{X}_{c}_{₀}_{,l,f}^{CL} 234 of the cleaner 230 is input to the NES 220, and the mask \hat{M}_{l,f}^{NES} 224 is applied to the output \hat{X}_{c}_{₀}_{,l,f}^{CL} 234 of the cleaner 230. Here, using the cleaner output \hat{X}_{c}_{₀}_{,l,f}^{CL} 234 as an input to the NES 220 has the benefit of providing the mask estimator 222 with a pre-enhanced version of the audio data 202.

For “NES->Cleaner”—the output \hat{X}_{c}_{₀}_{,l,f}^{LAEC} 218a of the LAEC 210 is input to the NES 220, and the output \hat{X}_{c}_{₀}_{,l,f}^{NES} 234 of the NES 220 is input to the cleaner 230, and the mask \hat{M}_{l,f}^{NES} 224 is applied to the output X̅_{c}_{₀}_{,l,f}^{LAEC} 218a of the LAEC 210. Here, the mask is computed using only microphone c₀ 16b and is applied to the other microphones 16b to not affect relative spatial cues between the microphones 16b. The cleaner 230 is then run on the output of NES 220. This allows the cleaner 230 to remove the final echo residuals after NES 220, at the possible expense of adding some distortion.

For “MM-NES”—the output \hat{X}_{c}_{₀}_{,l,f}^{LAEC} 218a of the LAEC 210 is input to the NES 220, and the output \hat{X}_{c}_{₀}_{,l,f}^{NES} 234 of the NES 220 is input to the cleaner 230, and the mask \hat{M}_{l,f}^{NES} 224 is applied to the output \hat{X}_{c}_{₀}_{,l,f}^{CL} 234 of the cleaner 230. Here, both the NES 220 and the cleaner 230 use the output \hat{X}_{c}_{₀}_{,l,f}^{LAEC} 218a of the LAEC 210, thus, providing the benefits of both without one being dependent on the other.

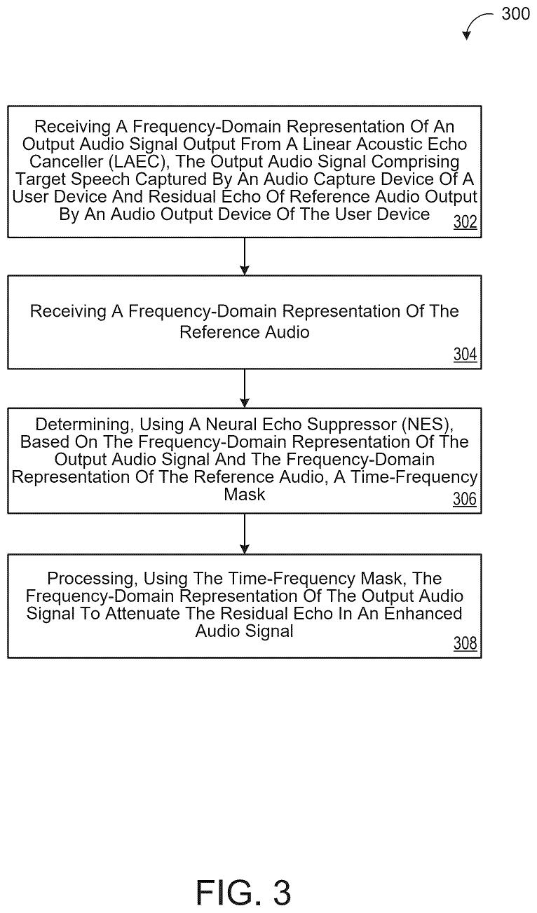

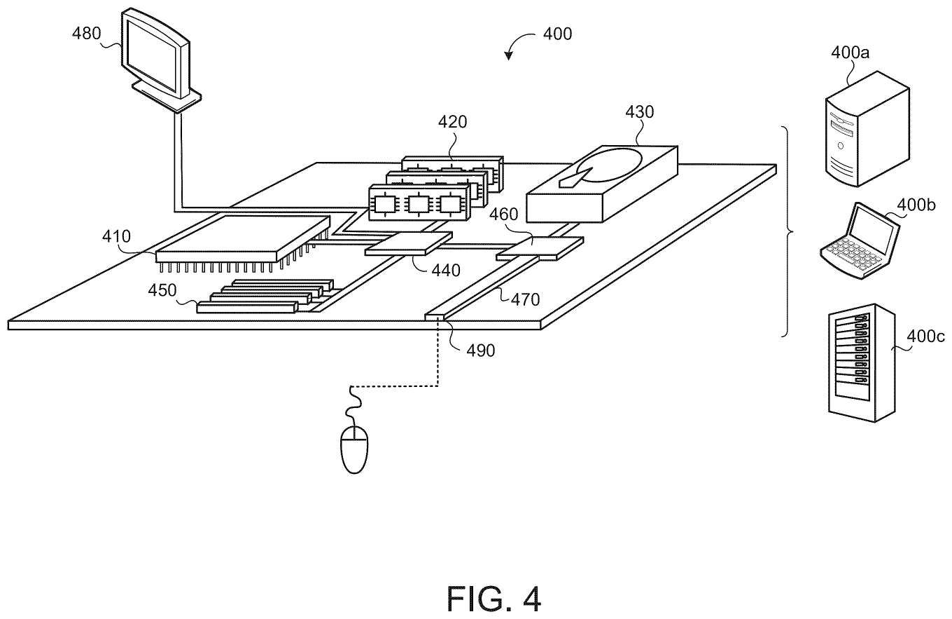

FIG. 3 is a flowchart of an example arrangement of operations for a method 300 of reducing residual acoustic echo after acoustic echo cancellation by the LAEC 210. The operations may be performed by data processing hardware 410 (see FIG. 4) (e.g., the data processing hardware 12 of the user device 10 or the data processing hardware 72 of the remote computing system 70) based on executing instructions stored on memory hardware 420 (FIG. 4) (e.g., the memory hardware 14 of the user device 10 or the memory hardware 74 of the remote computing system 70).

At operation 302, the method 300 includes receiving a frequency-domain representation \hat{X}_{c}_{₀}_{,l,f}^{LAEC} 218a of an output audio signal output from the LAEC 210, the output audio signal including target speech captured by an audio capture device 16b of a user device 10 and residual echo of reference audio 142 output by an audio output device 16a of the user device 10. At operation 304, the method 300 includes receiving a frequency-domain representation R_{l,f} 214 of the reference audio 142.

At operation 306, the method 300 includes determining, using the NES 220, based on the frequency-domain representation \hat{X}_{c}_{₀}_{,l,f}^{LAEC} 218a of the output audio signal and the frequency-domain representation R_{l,f} 214 of the reference audio 142, a time-frequency mask \hat{M}_{l,f}^{NES} 224. At operation 308, the method 300 includes processing, using the time-frequency mask \hat{M}_{l,f}^{NES} 224, the frequency-domain representation \hat{X}_{c}_{₀}_{,l,f}^{LAEC} 218a of the output audio signal to attenuate the residual echo in an enhanced audio signal \hat{X}_{c}_{₀}_{,l,f}^{NES} 228.

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 12 and/or 72, memory 420 (i.e., memory hardware) that can be used to implement the memory hardware 14 and/or 74, a storage device 430 (i.e., memory hardware) that can be used to implement the memory hardware 14 and/or 74, a high-speed interface/controller 440 connecting to the memory 420 and high-speed expansion ports 450, and a low speed interface/controller 460 connecting to a low speed bus 470 and a storage device 430 that can be used to implement the repository 240. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone: (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a frequency-domain representation of an output audio signal output from a linear acoustic echo canceller (LAEC), the output audio signal comprising target speech captured by an audio capture device of a user device and residual echo of reference audio output by an audio output device of the user device;
receiving a frequency-domain representation of the reference audio;
determining, using a neural echo suppressor (NES), based on the frequency-domain representation of the output audio signal and the frequency-domain representation of the reference audio, a time-frequency mask, and
processing, using the time-frequency mask, the frequency-domain representation of the output audio signal to attenuate the residual echo in an enhanced audio signal.

2. The computer-implemented method of claim 1, wherein the NES comprises one or more self-attention layers.

3. The computer-implemented method of claim 1, wherein the operations further comprise:
for each respective additional audio capture device of a plurality of additional audio capture devices of the user device, receiving a respective frequency-domain representation of a respective output audio signal output from the LAEC for the respective additional audio capture device, the respective output audio signal comprising respective residual echo; and
determining, using a cleaner, based on the respective frequency-domain representations of the respective output audio signals, an estimate of the attenuated residual echo.

4. The computer-implemented method of claim 3, wherein determining the estimate of the attenuated residual echo comprises correlating a frequency-domain representation of the enhanced audio signal with each of the respective frequency-domain representations of the respective output audio signals.

5. The computer-implemented method of claim 3, wherein:
the cleaner comprises a plurality of coefficients; and
the operations further comprise training the plurality of coefficients using a minimum mean square error criterion.

6. The computer-implemented method of claim 3, wherein:
the cleaner comprises a plurality of coefficients; and
the operations further comprise training the plurality of coefficients:
when target speech is not present; or
prior to detection of a keyword in target speech.

7. The computer-implemented method of claim 1, wherein:
the frequency-domain representation of the output audio signal comprises a plurality of log-compressed magnitudes for respective ones of a plurality of frequency sub-bands; and
the frequency-domain representation of the reference audio comprises a plurality of log-compressed magnitudes for respective ones of the plurality of frequency sub-bands.

8. The computer-implemented method of claim 1, wherein the operations further comprise, for each training step of a plurality of training steps:
generating target audio training data comprising sampled speech of interest and a version of an interfering signal;
processing, using the LAEC, the target audio training data and the interfering signal to generate predicted enhanced audio data, the LAEC configured to attenuate the interfering signal in the predicted enhanced audio data;
processing, using the NES, the predicted enhanced audio data to generate predicted further enhanced audio data, the NES configured to suppress the interfering signal in the predicted further enhanced audio data; and
training coefficients of the NES based on a loss term computed based on the predicted further enhanced audio data and the sampled speech of interest.

9. The computer-implemented method of claim 8, wherein processing, using the LAEC, the target audio training data and the interfering signal to generate the predicted enhanced audio data comprises using, for each training step, randomly sampled LAEC parameters.

10. The computer-implemented method of claim 9, wherein at least a portion of the randomly sampled LAEC parameters reduce a performance of the LAEC.

11. The computer-implemented method of claim 8, wherein the loss term comprises at least one of a time-domain scale-invariant signal-to-noise ratio, an automatic speech recognition encoder loss, or a masking loss.

12. The computer-implemented method of claim 1, wherein the LAEC is configured to perform echo cancellation based on a frequency-domain representation of the target speech and a frequency-domain representation of the reference audio.

13. The computer-implemented method of claim 12, wherein:
the LAEC is configured to perform echo cancellation based on a first set of frequency-domain sub-bands; and
the NES is configured to determine the time-frequency mask based on a second set of frequency-domain sub-bands different from the first set of frequency-domain sub-bands.

14. A system, comprising:
data processing hardware; and
memory hardware in communication with the data processing hardware, the memory hardware storing instructions that when executed on the data processing hardware cause the data processing hardware to perform operations comprising:
receiving a frequency-domain representation of an output audio signal output from a linear acoustic echo canceller (LAEC), the output audio signal comprising target speech captured by an audio capture device of a user device and residual echo of reference audio output by an audio output device of the user device;
receiving a frequency-domain representation of the reference audio;
determining, using a neural echo suppressor (NES), based on the frequency-domain representation of the output audio signal and the frequency-domain representation of the reference audio, a time-frequency mask; and
processing, using the time-frequency mask, the frequency-domain representation of the output audio signal to attenuate the residual echo in an enhanced audio signal.

15. The system of claim 14, wherein the NES comprises one or more self-attention layers.

16. The system of claim 14, wherein the operations further comprise:
for each respective additional audio capture device of a plurality of additional audio capture devices of the user device, receiving a respective frequency-domain representation of a respective output audio signal output from the LAEC for the respective additional audio capture device, the respective output audio signal comprising respective residual echo; and
determining, using a cleaner, based on the respective frequency-domain representations of the respective output audio signals, an estimate of the attenuated residual echo.

17. The system of claim 16, wherein determining the estimate of the attenuated residual echo comprises correlating a frequency-domain representation of the enhanced audio signal with each of the respective frequency-domain representations of the respective output audio signals.

18. The system of claim 16, wherein:
the cleaner comprises a plurality of coefficients; and
the operations further comprise training the plurality of coefficients using a minimum mean square error criterion.

19. The system of claim 16, wherein:
the cleaner comprises a plurality of coefficients; and
the operations further comprise training the plurality of coefficients:
when target speech is not present; or
prior to detection of a keyword in target speech.

20. The system of claim 14, wherein:
the frequency-domain representation of the output audio signal comprises a plurality of log-compressed magnitudes for respective ones of a plurality of frequency sub-bands; and
the frequency-domain representation of the reference audio comprises a plurality of log-compressed magnitudes for respective ones of the plurality of frequency sub-bands.

21. The system of claim 14, wherein the operations further comprise, for each training step of a plurality of training steps:
generating target audio training data comprising sampled speech of interest and a version of an interfering signal;
processing, using the LAEC, the target audio training data and the interfering signal to generate predicted enhanced audio data, the LAEC configured to attenuate the interfering signal in the predicted enhanced audio data;
processing, using the NES, the predicted enhanced audio data to generate predicted further enhanced audio data, the NES configured to suppress the interfering signal in the predicted further enhanced audio data; and
training coefficients of the NES based on a loss term computed based on the predicted further enhanced audio data and the sampled speech of interest.

22. The system of claim 21, wherein processing, using the LAEC, the target audio training data and the interfering signal to generate the predicted enhanced audio data comprises using, for each training step, randomly sampled LAEC parameters.

23. The system of claim 22, wherein at least a portion of the randomly sampled LAEC parameters reduce a performance of the LAEC.

24. The system of claim 21, wherein the loss term comprises at least one of a time-domain scale-invariant signal-to-noise ratio, an automatic speech recognition encoder loss, or a masking loss.

25. The system of claim 14, wherein the LAEC is configured to perform echo cancellation based on a frequency-domain representation of the target speech and a frequency-domain representation of the reference audio.

26. The system of claim 25, wherein:
the LAEC is configured to perform echo cancellation based on a first set of frequency-domain sub-bands; and
the NES is configured to determine the time-frequency mask based on a second set of frequency-domain sub-bands different from the first set of frequency-domain sub-bands.
